(19) United States
(12) Patent Application Publication
(10) Pub. No.: US 2011/0148713 A1
(43) Pub. Date: Jun. 23, 2011

(54) Apparatus And Method For Tracking Stolen Vehicles

(76) Inventor: Robert F. D'Avello, Lake Zurich, IL (US)

(21) Appl. No.: 12/643,862

(22) Filed: Dec. 21, 2009

(51) Int. Cl. G01S 3/02

(52) U.S. Cl. 342/457

(57) ABSTRACT

An indication that jamming is occurring with vehicular communications is received. When activated by a control signal from a vehicle recovery service, a vehicle location signal is transmitted over a channel in the communication network that enables the vehicle recovery service to track a location of the vehicle. When the indication of jamming is received and before the control signal is received, the vehicle location signal is also transmitted to the vehicle recovery service.

### CROSS REFERENCES TO RELATED APPLICATIONS

“Apparatus and Method of Detecting Jamming of Communications” having attorney docket number DP10050 (93738)

“Apparatus and Method for Broadcasting the Detection of RF Jammer Presence” having attorney docket number DP 10051 (94690)

“Apparatus and Method for Compromised Vehicle Tracking” having attorney docket number DP10052 (94691)

Apparatus and Method for Detecting a Cloned Base Station” having attorney docket number DP10053 (93740)

“Apparatus and Method for detecting Communication Interference” having attorney docket number DP10054 (93739)

“Apparatus and Method for Detecting a Cloned Base Station” having attorney docket number DP10055 (93741)

“Apparatus and Method for Determining an Invalid Base Station” having attorney docket number DP10056 (97058)

“Apparatus and Method for Determining Vehicle Location” having attorney docket number DP10057 (97059)

“Apparatus and Method for Maintaining Communication with a Stolen Vehicle Tracking Device” having attorney docket number DP10058 (97060)

“Apparatus and Method for Reducing False Alarms in Stolen Vehicle Tracking” having attorney docket number DP10059 (97061)

“Apparatus and Method for Maintaining Communications with a Vehicle in the Presence of Jamming” having attorney docket number DP 10061 (97102)

all of which are being filed on the same date as the present application and all of which having their contents incorporated herein by reference in their entireties.

### FIELD OF THE INVENTION

The field of the invention relates to communications between various entities and, more specifically to detect the jamming or attempted jamming of these communications and tracking stolen vehicles in the presence of jamming.

### BACKGROUND

Vehicles are equipped with various types of communication systems that provide or facilitate various types of functions. For instance, a vehicle may be equipped with a global positioning satellite (GPS) system that provides for locating the vehicle and providing information concerning the location of the vehicle to a user. Vehicle security systems are also employed in many vehicles to protect the vehicle and its contents from theft or other criminal activity. For example, a vehicular security system may be configured to communicate with some outside entity (e.g., a police or security center) and when an attempt is made to break into a vehicle, the vehicular security system may transmit messages to the outside entity where appropriate action may be taken to prevent or stop the break in. Some jurisdictions even require the use of security systems in vehicles because of the high number of vehicle break-ins or thefts in these areas.

If a vehicle is stolen, stolen vehicle tracking (SVT) applications attempt to track and sometimes recover the stolen vehicle. To give one example, some SVT applications rely upon a GPS system to pinpoint the location of the vehicle and a Global System for Mobile communications (GSM) cellular network to report the incident to a service provider via Short Message Service (SMS) or General Packet Radio Service (GPRS) data connections.

Some systems can be used to track vehicles once the vehicle is stolen. To provide one example, the system provided by LoJack Corporation provides stolen vehicle recovery functions by installing a small transmitter in the vehicle. When a user reports that the vehicle has been stolen, this information is passed on to the LoJack service provider. The LoJack system then transmits a signal to the vehicle. The vehicle then transmits a signal that is intended to assist law enforcement officials with locating the vehicle. The law enforcement officials can have LoJack equipment installed in their vehicles. In addition, there may be additional dedicated LoJack receivers along with receivers mounted in aircraft and other vehicles or locations. The signals received by each of these receivers can be combined to triangulate and track the position of the stolen vehicle.

Potential thieves have sometimes attempted to jam the receiver hardware located at the vehicle by employing devices that create a strong wide-band signal in the receive band and thereby block the GPS satellite from being received at the vehicle and/or to block GSM network signals that are sent from the cellular base station to the vehicle. Previous attempts at detecting such jamming and/or attempted jamming and reporting these actions to a security center have generally been unsuccessful and/or expensive to accomplish. Once jamming occurs, previous approaches have also proved inadequate in tracking the location of the vehicle.

### BRIEF DESCRIPTION OF THE DRAWINGS

FIG. 1 comprises a block diagram of a system that detects the jamming and/or attempted jamming of communications and tracks a vehicle in the presence of this jamming according to various embodiments of the present invention;

FIG. 2 comprises a block diagram of an apparatus that detects the jamming and/or attempted jamming of communications and tracks a vehicle in the presence of this jamming according to various embodiments of the present invention;

FIG. 3 comprises a flowchart of one example of an approach for detecting the jamming and/or attempted jamming of communications at a vehicle and the tracking of the vehicle in the presence of this jamming according to various embodiments of the present invention;

FIG. 4 comprises a flowchart of another example of an approach for detecting the jamming and/or attempted jamming of communications at a vehicle and the tracking of the vehicle in the presence of this jamming according to various embodiments of the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Approaches are provided where after jamming is detected, a vehicle recovery device already disposed at a vehicle is actuated to transmit a vehicle location signal to a vehicle recovery service that can locate, track, and possibly recover the stolen vehicle. In other words, the vehicle recovery device is automatically triggered by the detection of jamming and does not have to wait for a control signal from a user or vehicle recovery service to begin transmitting. The approaches described herein are easy to use, accurate in determining the occurrence of a jamming or attempted jamming, effective in tracking and locating the vehicle, and cost effective to implement resulting in enhanced security and the quick recovery of stolen vehicles and their contents.

In many of these embodiments, communications are conducted between at least one mobile device in a vehicle and a base station in a communication network. Communications may also be conducted with a navigation system. At a jamming detection device or module at the vehicle, jamming is detected as occurring with any of these communications. At a vehicle tracking module or device at the vehicle and when activated by a control signal from a vehicle recovery service, a vehicle location signal is transmitted over a channel in the communication network that enables the vehicle recovery service to track a location of the vehicle. Additionally, when jamming is detected and before the control signal is received, the vehicle location signal is also transmitted to the vehicle recovery service.

The communication network can be various types of networks. For example, the communication network is a cellular network. In one example, the cellular network is a Global System for Mobile communications (GSM) cellular network. Other examples of networks are possible.

In other aspects, the vehicle location signal is received at the vehicle recovery service and the vehicle is tracked. The vehicle recovery service can be a variety of different authorities or agencies. For example, the vehicle recovery service may be a police authority or a private security agency (e.g., affiliated with a vehicle recovery service provided by the Lojack Corporation). Various tracking approaches may also be used. For example, the location of the vehicle may be determined using triangulation approaches. Other examples of tracking and vehicle location determination approaches may also be used. Further, various frequencies or channel types can also be used to make the transmissions. For instance, a dedicated stolen vehicle tracking (SVT) channel can be used to mention one example.

In others of these embodiments, an indication that jamming is occurring with vehicular communications is received. When activated by a control signal from a vehicle recovery service, a vehicle location signal is transmitted over a channel in the communication network that enables the vehicle recovery service to track the location of the vehicle. Additionally, when the indication of jamming is received and before the control signal is received, the vehicle location signal is also transmitted to the vehicle recovery service.

In still others of these embodiments, an apparatus for sending a warning that a vehicle is being stolen includes an interface and a controller. The interface has an input and output and receives an indication via the input of the interface that jamming of some or all of communications at a vehicle is occurring. The controller is coupled to the interface and configured to receive a control signal from a vehicle recovery service and to responsively transmit a vehicle location signal at the output of the interface. The vehicle location signal is transmitted over a channel in the communication network that enables the vehicle recovery service to track the location of the vehicle. The controller is further configured to, when the indication of jamming is received and before the control signal is received, transmit the vehicle location signal at the output of the interface to the vehicle recovery service.

The approaches described herein do not wait for a transmission from the service provider (e.g., a LoJack service provider) to start transmissions from the vehicle recovery device (e.g., a LoJack transceiver). Once triggered by the detection of jamming and begins transmitting, the vehicle can be tracked and located by the service provider and since there is no waiting for the service provider to provide a control signal, vehicle recovery can be obtained much more quickly than previous approaches.

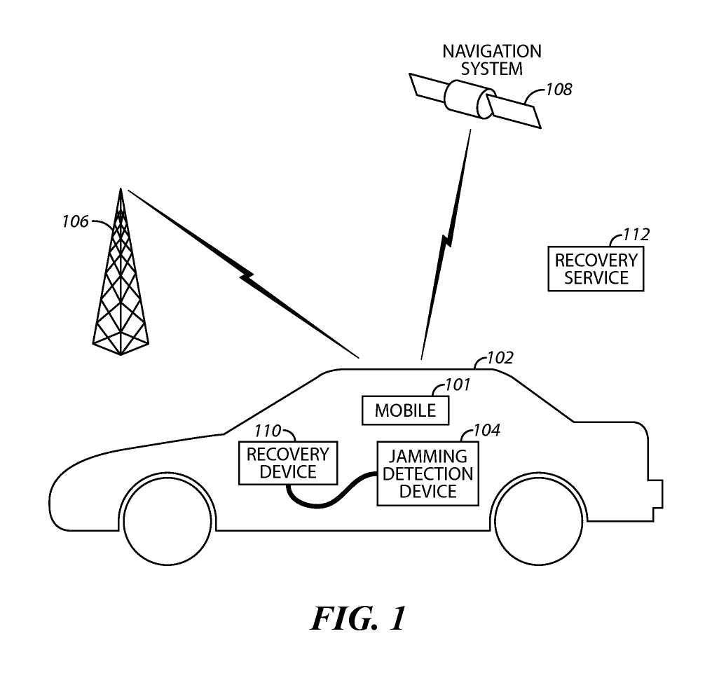

Referring now to FIG. 1, one example of a system for detecting the jamming of vehicular communications and tracking stolen vehicles in the presence of jamming is described. A vehicle 102 includes a communication and jamming detection device 104 and a mobile device 101. The communication and jamming detection device 104 is disposed anywhere in or at the vehicle 102 and communicates with a base station 106 and an external navigation system 108. The vehicle 102 also includes a vehicle recovery device 110 that communicates with an external vehicle recovery service provider 112.

The mobile device 101 may be any type of mobile wireless unit. For example, the mobile device 101 may be a cellular phone, pager, personal digital assistant, personal computer to mention a few examples. Other examples are possible.

The communication and jamming detection device 104 may be, in one example, a programmed electronic device that determines the location of the vehicle 102 from signals received from the navigation system 108 and determines if jamming and/or attempted jamming is occurring as to signals being received and/or being transmitted. Alternatively, another separate device may be used to determine the location of the vehicle and this separate device may communicate with the communication and jamming detection device 104. The external navigation system 108 may be a GPS satellite or satellite system, in one example.

Jamming (or attempted jamming) is determined with any of the signals transmitted and/or received from the mobile device 101, the communication and jamming detection device 104, the vehicle recovery device 110, the navigation system 108, and/or any other electronic device at the vehicle 102 that is configured to transmit and/or receive communications. The jamming of any of these signals causes the operation of the vehicle recovery device 110 to be activated and a signal to be transmitted to the service provider 112. The signal can be transmitted to the service provider 112 over the network infrastructure in one example.

Jamming can be determined in a variety of different ways. In some examples, as described in co-pending application entitled “Apparatus and Method for Detecting Jamming of Communications” filed on the same date as the present application and having attorney docket number DP10050, a signal strength indicator is a numeric value that generally indicates the strength of a received signal in cellular communication systems. More specifically, the signal strength indicator is a value that indicates the magnitude of the signals that are transmitted and received within these systems.

A first rate of rise of a signal strength indicator associated with the first communication channel and a second rate of rise of a signal quality indicator associated with the first communication channel are monitored. The signal strength indicator may be a received signal strength indicator (Rx Level) and the signal quality indicators may be the RX quality level (Rx Qual). When at least one of the first rate rises at a rate greater than a first predetermined threshold rate and the second rate rises at a rate greater than a second predetermined threshold rate, jamming can be determined to exist.

Any number of antennas may be used by the communication device 104. In one example two antennas are used and one antenna is used to transmit signals and the other is used to receive signals. In other examples, multiple TX and RX antennas can be used with some of the antennas being used as backup antennas. If the path loss abruptly changes, then the device can switch antennas. In one aspect, when jamming is occurring (or detected to be occurring) then the device can switch antennas and attempt to communicate on the backup antenna or backup antennas. In still other examples, a single antenna is used.

Many of the approaches described herein are described as being executed by devices that are at least partially disposed at or within a vehicle. However, it will be appreciated that the approaches described herein are not limited to devices that can be disposed at or within vehicles, but can be used with devices that are disposed at any location such as within homes, businesses, or even with individuals that are not within or associated with a vehicle.

The vehicle 102 may be any type of vehicle such as a car, truck, bus, airplane, ship, to name a few examples. The communication device 104 is any type of communication device that communicates with entities outside the vehicle 102 using any type of communication technology or protocol. For example, the communication device 104 may be or may incorporate a cellular phone, transponder, radio, or some combination of these or other devices.

The vehicle recovery device 110 is, in one example. a small transmitter in the vehicle such as a transceiver as provided by LoJack Corporation. When a user reports that the vehicle 102 has been stolen, this information is passed on to the service provider 112. The service provider 112 (or others associated with the service provider 112) then transmits a control signal to the vehicle 102. The vehicle 102 then begins transmitting a signal that is intended to assist law enforcement officials (or other authorized parties) with locating the vehicle 102. In the case of LoJack equipment, the law enforcement officials may be provided with LoJack equipment installed in their vehicles. In addition, there may be additional dedicated LoJack receivers along with receivers mounted in aircraft and so forth. The signals received by each of these can be combined to triangulate and track the position of the stolen vehicle 102. Other location determination and tracking approaches can also be used.

The approaches described herein do not wait for a transmission from the service provider 112 to activate the vehicle recovery device 110. More specifically, the communication and jamming detection device 104 couples to the vehicle recovery device 110 via a wired or wireless link. Once jamming is detected by the device 104, a signal is sent to trigger the vehicle recovery device 110. Once the vehicle recovery device 110 begins transmitting, the vehicle 102 can be tracked and located by the provider 112 as described above. In other words, the provider 112 does not provide a trigger based upon the condition of interference to GSM and/or GPS system reception. To the contrary, the device 104 provides this function so as to activate the vehicle recovery device 110 in order that the vehicle can be located, tracked, and recovered quickly and efficiently.

The external vehicle recovery service provider 112 is any entity authorized to activate the vehicle recovery device 110 and/or track the vehicle 102 via signals from the device 110. In one example, the provider 112 may be a private agency (e.g., affiliated with the LoJack Corporation) and/or the police. Other examples of service providers are possible.

In one example of the operation of the system of FIG. 1, communications are conducted between the mobile device 101 at the vehicle 102 and the base station 106 in a communication network, and/or between the device 104 and the navigation system 108. At the jamming detection device 104 at the vehicle 102, jamming is detected as occurring with any of these communications. At the vehicle recovery device 110 and when activated by a control signal from a service provider, a vehicle location signal is transmitted over a channel in the communication network that enables the service provider 112 to track the location of the vehicle 102. When jamming is detected and before the control signal is received, the vehicle location signal is also transmitted to the service provider 112.

The communication network can be various types of networks. For example, the communication network comprises a cellular network. In one example, the cellular network is a Global System for Mobile communications (GSM) cellular network. Other examples of networks are possible.

In other aspects, the signal is received at the vehicle recovery service 112 and the vehicle 102 is tracked. As mentioned, the vehicle recovery service 110 can be a variety of different authorities or agencies. For example, the vehicle recovery service 110 may be a police authority and a private security agency.

Various tracking approaches may also be used. For example, the location of the vehicle may be determined using triangulation approaches. Other examples are possible. Various frequencies or channel types can also be used to make the transmissions. For instance, a dedicated stolen vehicle tracking (SVT) channel to mention one example.

In another example of the operation of the system of FIG. 1, an indication that jamming is occurring with the communications is received at the vehicle recovery device 110. When activated by a control signal from a service provider 112, a vehicle location signal is transmitted over a channel in the communication network that enables the service provider 112 to track a location of the vehicle 102. When the indication of jamming is received and before the control signal is received, the vehicle location signal is also transmitted to the service provider 112.

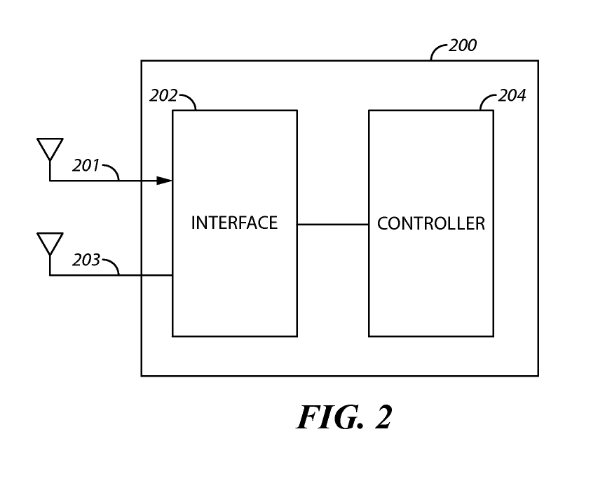

Referring now to FIG. 2, one example of an apparatus 200 for sending a warning that a vehicle is being stolen includes an interface 202 and a controller 204. The interface 202 has an input 201 and output 203 and receives a indication at the input that jamming of communications at a vehicle.

The controller 204 is coupled to the interface 202 and configured to receive a control signal from a vehicle recovery system at the input 201 and to responsively transmit a vehicle location signal at the output 203. The vehicle location signal is transmitted over a channel in the communication network that enables a service provider to track a location of the vehicle. The controller 204 is further configured to, when the indication of jamming is received and before the control signal is received, transmit the vehicle location signal at the output 203 of the interface 202.

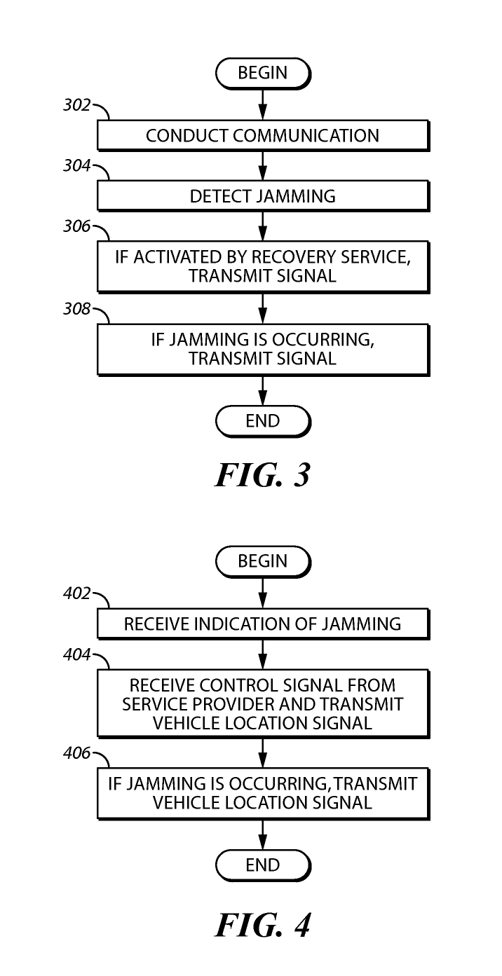

Referring now to FIG. 3, one example of an approach for tracking a stolen vehicle in the presence of jamming is described. At step 302, communications are conducted between some electronic device in the vehicle (e.g., a mobile wireless device, a jamming detection device, a location determination and navigation device) and the base station in a communication network (or some other outside entity such as a satellite navigation system).

At step 304 and the jamming detection device (at the vehicle), jamming is detected as occurring with the communications as to any electronic device in the vehicle. As mentioned, jamming can be determined in a variety of different ways. For example, a first rate of rise of a signal strength indicator associated with the first communication channel and a second rate of rise of a signal quality indicator associated with the first communication channel are monitored. The signal strength indicator may be a received signal strength indicator (Rx Level) and the signal quality indicators may be the RX quality level (Rx Qual). When at least one of the first rate rises at a rate greater than a first predetermined threshold rate and the second rate rises at a rate greater than a second predetermined threshold rate, jamming can be determined to exist. And as mentioned, the jamming can be determined as to any of the signals in the network such as with a mobile device (e.g., GSM signals) or a navigation system (e.g., GPS signals).

At step 306 and at the vehicle recovery device (at the vehicle), when activated by a control signal from a service provider, a vehicle location signal is transmitted over a channel in the communication network that enables the service provider to track a location of the vehicle. This may occur with no jamming.

The vehicle location determination signal may be any signal that can be used to locate a vehicle. In this regard, it may or may not carry information useful for location determination (e.g., vehicle identifiers, last known vehicle location, and so forth). The signal may be transmitted periodically or randomly. It may be transmitted a single time or, as mentioned, periodically and continuously. Further, the signal is of sufficient strength and power to allow tracking to occur. The signal may be sent over any communication channel and in one example is sent over a dedicated SVT channel.

At step 308 and at the vehicle recovery device (at the vehicle), when jamming is detected and before the control signal is received, the vehicle location signal is also transmitted to the service provider. Consequently, the signal is sent automatically as soon jamming is detected thereby increasing the speed whereby the stolen vehicle can be recovered.

Referring now to FIG. 4, another example of an approach for tracking a stolen vehicle in the presence of jamming is described. At step 402, an indication that jamming is occurring with the communications is received at the vehicle recovery device. The signal may be sent by a jamming detection device also at the vehicle.

At step 404 and when activated by a control signal from a service provider, a vehicle location signal is transmitted over a channel in the communication network that enables the service provider to track a location of the vehicle. For example, the control signal may be sent by a LoJack service provider. In this case, an owner may have informed the service that their car is stolen and the control signal is sent by the service to activate the recovery device in the vehicle. Jamming may or may not be occurring in this situation.

The vehicle location determination signal may be any signal that can be used to locate a vehicle. In this regard, it may or may not carry information useful for location determination (e.g., vehicle identifiers, last known vehicle location, and so forth). The signal may be transmitted periodically or randomly. It may be transmitted a single time or, as mentioned, periodically and continuously. Further, the signal is of sufficient strength and power to allow tracking to occur. The signal may be sent over any communication channel and in one example is sent over a dedicated SVT channel.

At step 406 and when the indication of jamming is received and before the control signal is received, the vehicle location signal is also transmitted to the service provider. Once received by the service provider, appropriate authorities can be informed and the vehicle tracked. In addition, since the service provider is aware that a signal has been received but that the service provider has not instigated or triggered the device in the vehicle, jamming is occurring and appropriate action need be taken. In this case, the presence of jamming triggers the transmission of a vehicle location signal so that the vehicle can be located and recovered.

Thus, approaches are provided where after jamming is detected, a vehicle recovery system already in the vehicle is triggered to send a vehicle location signal to an outside entity that can locate, track, and possibly recover the stolen vehicle. In other words, the vehicle recovery system is automatically triggered by the detection of jamming and does not have to wait for a control signal from a recovery service. The approaches described herein are easy to use, accurate in determining the occurrence of a jamming or attempted jamming, effective in tracking and locating the vehicle, and cost effective to implement resulting in enhanced security for vehicles and the quick recovery of the vehicle and its contents.

Those skilled in the art will recognize that a wide variety of modifications, alterations, and combinations can be made with respect to the above described embodiments without departing from the spirit and scope of the invention, and that such modifications, alterations, and combinations are to be viewed as being within the scope of the invention.

What is claimed is:

1. A method of tracking a stolen vehicle, comprising:
conducting communications between at least one device in a vehicle and at least one of: a base station in a communication network and an external navigation system; at a jamming detection module at the vehicle:
detecting that jamming is occurring with at least some of the communications; at a vehicle tracking device at the vehicle:
when activated by a control signal from a vehicle recovery service, transmitting a vehicle location signal over a channel in the communication network allowing a vehicle recovery service to track a location of the vehicle;
when jamming is detected and before the control signal is received, transmitting the vehicle location signal to the vehicle recovery service over the channel.

2. The method of claim 1 wherein the communication network comprises a cellular network.

3. The method of claim 1 further comprising receiving the signal at the vehicle recovery service and tracking the vehicle.

4. The method of claim 3 wherein the vehicle recovery service is selected from the group consisting of a police authority and a private security agency.

5. The method of claim 3 wherein the tracking comprises determining the location of the vehicle using triangulation approaches.

6. The method of claim 1 wherein the channel comprises a dedicated stolen vehicle tracking (SVT) channel.

7. An apparatus for sending a warning that a vehicle is being stolen, comprising:
an interface having an input and output and for receiving a indication at the input that jamming of communications at a vehicle;
a controller coupled to the interface and configured to receive a control signal from a vehicle recovery service and to responsively transmit a vehicle location signal at the output, the vehicle location signal being over a channel in the communication network that enables the vehicle recovery service to track a location of the vehicle, the controller being further configured to when the indication of jamming is received and before the control signal is received, transmit the vehicle location signal at the output of the interface to the vehicle recovery service.

8. The apparatus of claim 7 wherein the channel is a dedicated stolen vehicle tracking (SVT) channel.

9. The apparatus of claim 7 wherein the communication network comprises a cellular network.

10. A computer usable medium having a computer readable program code embodied therein, said computer readable program code adapted to be executed to implement a method of tracking a stolen vehicle, comprising:
conducting communications between at least one device in a vehicle and at least one of: a base station in a communication network and an external navigation system; at a jamming detection module at the vehicle:
detecting that jamming is occurring with at least some of the communications; at a vehicle tracking device at the vehicle:
when activated by a control signal from a vehicle recovery service, transmitting a vehicle location signal over a channel in the communication network allowing a vehicle recovery service to track a location of the vehicle;
when jamming is detected and before the control signal is received, transmitting the vehicle location signal to the vehicle recovery service over the channel.

11. The computer usable medium of claim 10 wherein the communication network comprises a cellular network.

12. The computer usable medium of claim 10 further comprising receiving the signal at the vehicle recovery service and tracking the vehicle.

13. The computer usable medium of claim 12 wherein the vehicle recovery service is selected from the group consisting of a police authority and a private security agency.

14. The computer usable medium of claim 12 wherein the tracking comprises determining the location of the vehicle using triangulation approaches.

15. The computer readable medium of claim 10 wherein the channel comprises a dedicated stolen vehicle tracking (SVT) channel.
